(19) United States
(12) Patent Application Publication
(10) Pub. No.: US 2026/0271951 A1
(43) Pub. Date: Sep. 17, 2026

(54) LOW SUGAR OAT BASE OR OAT DRINK

(71) Applicant: Oatly AB, MALMÖ (SE)

(72) Inventors: Matilda Ulmius Storm, MALMÖ (SE); Johan Qvist, MALMÖ (SE); Karin Petersson, MALMÖ (SE); Sofia Ehlde, MALMÖ (SE); Aimee Aidala, New York, NY (US)

(21) Appl. No.: 19/157,086

(22) PCT Filed: Nov. 10, 2023
(86) PCT No.: PCT/EP2023/081485

§ 371 Date: Aug. 15, 2025

(30) Foreign Application Priority Data
Feb. 17, 2023 (WO) PCT/EP2023/054088
Feb. 17, 2023 (WO) PCT/EP2023/054089

(51) Int. Cl. A23C 11/10; A23L 2/38; A23L 2/52; A23L 7/104

(52) U.S. Cl. CPC A23C 11/10; A23L 2/382; A23L 2/52; A23L 7/107

(57) ABSTRACT

A liquid oat base or oat drink includes an oat derived material with 1-25% by weight dry substance, based on the weight of the liquid oat base or oat drink, wherein the oat derived material has, by dry weight of the oat derived material, DP1 to DP2 sugars in an amount of 7% or below, and DP3 to DP8 oligosaccharides in an amount of 5-40%. Also disclosed is a method for production of a liquid oat base or oat drink.

### TECHNICAL FIELD

The present disclosure relates to a liquid oat base or oat drink, and to a method for production of a liquid oat base or oat drink.

### BACKGROUND

There is a growing interest in refraining from consumption of dairy products and from meat products, for example for health reasons, and sustainability reasons. In addition, there is a growing trend to choose products for consumption in the daily life which contribute to a positive climate impact. This may mean excluding or at least reducing intake of dairy based products as well as meat products.

Oat is well known for containing nutritious compounds and may be considered a sustainable vegetable ingredient in food production. Oat in different forms is therefore an often used ingredient in healthy and nutritious foods. For example, use of oats in production of oat-containing aqueous liquid, sometimes referred to as an oat base, is well known. Such an oat base may be used as ingredient or base for manufacturing of different food products, for example, analogues for dairy products. Oat beverage, such as an oat drink, also referred to as oat milk, is one well known example. Such oat-based milk substitutes are preferred by many consumers for various reasons, for example for providing a content of soluble beta-glucan fibre beneficial to health, lack of potentially allergenic proteins, lack of lactose which cannot be digested by the majority of the global population, and for a desirable taste.

In spite of the commercial success of oat based milk substitutes available on the market, there is room for further improvement. For example, there is a further interest amongst consumers towards low-sugar products and for products with less sweet taste. It is however problematic to provide products that are low in sugar but at the same time provides desirable taste and/or mouth-feel when consumed.

Thus, there is a need for non-dairy milk like products, such as oat bases or oat drinks, which are low in sugar, but associated with desirable other properties, for example, desirable flavour and mouthfeel.

### SUMMARY

It is an object of the present disclosure to, at least partly, solve at least one problem or need of prior art.

It is a further object of the present disclosure to, at least partly, provide an improved liquid oat base or oat drink.

It is a yet further object of the present disclosure to, at least partly, provide an improved liquid oat or oat drink that has a low content of sugar.

According to a first aspect there is provided a liquid oat base or oat drink comprising an oat derived material with 1-25% by weight dry substance, based on the weight of the liquid oat base or oat drink. The oat derived material comprises, by dry weight of the oat derived material,
DP1 to DP2 sugars present in an amount of 7% or below, and
DP3 to DP8 oligosaccharides present in an amount of 5-40%.

Such content of DP1-DP2 sugars in combination with the defined levels of DP3-DP8 oligosaccharides provides a liquid oat base or oat drink that is low in sugar, while at the same time being rich in taste and associated with a desirable body or mouthfeel. By ensuring such levels of sugars and oligosaccharides, the liquid oat base or oat drink has improved mouthfeel and lower sugar as compared to prior art products.

The herein described content of DP1-DP2, DP3 to DP8 oligosaccharides, and any optional DP9 and larger polysaccharides, including starch at various levels of degradation, provides the liquid oat base or oat drink with unique properties, while at the same time resulting in a product that is low in sugar content. In fact, also oat bases and oat drinks without any sugar were manufactured. However, products with a low, but present, content of sugar were described as having a preferred flavour. In addition, this is achieved at a minimum level of oat derived material dry substance of 1-25% by weight of the oat base or oat drink, which allows adding to richness and mouthfeel.

The oat derived material may further comprise DP9 and larger polysaccharides, present in an amount of 25-75%, by weight of the oat derived material.

Such content of DP9 and larger polysaccharides in combination with the level of DP1-DP2 sugars and level of DP3-DP8 oligosaccharides, provides a liquid oat base or oat drink that is low in sugar, while at the same time being associated with a desirable mouthfeel.

The specific content of carbohydrates from DP1 and up to large starch molecules may be achieved by partly hydrolysation of starch from oats, and such an oat base or oat drink therefore may be considered to comprise partly hydrolysed or partly liquified starch. The presence of partly hydrolysed starch, which may comprise polysaccharides, oligosaccharides and low levels DP1-DP2 sugars is believed to contribute even further to desirable flavours as well as other beneficial sensory related properties, including improved richness, creaminess, and mouthfeel, of the oat base or oat drink.

The DP9 and larger polysaccharides may be comprised by the oat derived material.

For the oat base or oat drink according to the first aspect, the DP3 to DP8 oligosaccharides may be present in an amount of 15-35%.

The DP9 and larger polysaccharides may be present in an amount of 25-50%.

The liquid oat base or oat drink having a content of DP3 to DP8 oligosaccharides in an amount of 15-35%, and DP9 and larger polysaccharides present in an amount of 25-50%, may further comprise, by dry weight of the oat derived material: DP1 to DP2 sugars present in an amount of 2-5%; DP3-DP8 oligosaccharides present in an amount of 15-35%; and DP9 and larger polysaccharides in an amount of 30-50%.

It is appreciated that such an oat base or oat drink, with low levels of DP1-DP2 sugars, may be obtained by degradation of starch using amylases with alpha- and beta-activity.

The oat derived material for such an oat base or oat drink may have 7-25%, or 8-15%, by weight dry substance based on the weight of the liquid oat base or oat drink.

Alternatively, The oat derived material for such an oat base or oat drink may have 1-7%, or 1-5%, such as 2-4%, or around 3%, by weight dry substance based on the weight of the liquid oat base or oat drink. Such an oat base or oat drink may be combined with a presence of citrus fibre in the liquid oat base or oat drink.

For the oat base or oat drink according to the first aspect, the DP3 to DP8 oligosaccharides may be present in an amount of 5-15%.

The DP9 and larger polysaccharides may be present in an amount of 50-75%.

By dry weight of the oat derived material: DP1 to DP2 sugars may be present in an amount of 1-3%; DP3-DP8 oligosaccharides may be present in an amount of 5-15%; and DP9 and larger polysaccharides may be present in an amount of 50-75%.

It is appreciated that such an oat base or oat drink, with extra low levels of DP1-DP2 sugars, may be obtained by degradation of starch using amylases having alpha-activity, but no, or essentially no, beta-activity. Such low level of sugar may be originating from a natural level of sugar, such as sucrose, present in the oats also prior to hydrolysation.

The oat derived material of such an oat base or oat drink may have 7-25%, or 8-15%, by weight dry substance based on the weight of the liquid oat base or oat drink.

The liquid oat base or oat drink may comprise partly degraded starch.

Such partly hydrolysed starch may be defined by the presence or levels of oligosaccharides and polysaccharides. In addition, DP2 may be comprised by the partly hydrolysed starch.

10% by weight or less of the DP1 to DP2 sugar may be glucose; and 90% or more of the DP1 to DP2 sugar may be one or both of maltose and sucrose.

Maltose may provide the oat base or oat drink with a desirable rounder sweetness, as compared to glucose. Glucose may provide a sharper and less desirable sweetness.

In particular, the DP1-DP2 sugars may comprise less than 1% glucose, or the oat derived material may be free of glucose.

The oat derived material may have 7-25% by weight dry substance, based on the weight of the liquid oat base or oat drink.

The liquid oat base or oat drink may comprise, based on the dry weight of the liquid oat base or oat drink, 5-20% protein, and 3-35% fat.

The oat derived material may comprise 0.5-10%, by weight, of soluble fibres in form of beta-glucan, of which a weight-average molecular weight and above corresponds to intact or native beta-glucans.

Thereby, high nutritional values are provided, and in combination with the defined levels of carbohydrates in the oat base or oat drink desirable organoleptic properties are achieved. Presence of intact or native beta-glucans contributes to an improved and increased body of the oat base or oat drink.

The liquid oat base or oat drink may further comprise, in addition to the oat derived material, additives or ingredients. The additives and ingredients may be selected from one or more of vegetable fat, vitamin, buffering agent, salt and mineral.

Buffering agent may be one or more selected from group consisting of potassium phosphates, potassium citrates, sodium citrates, calcium phosphates, calcium carbonates and potassium carbonates.

The salt may be sodium chloride. The salt may be selected from one or more of NaCl, Ca-Carbonate and DiKPhosphate.

The oat derived material may be present in an amount of 5-25% by weight dry substance, based on the weight of the liquid oat base or oat drink.

Such amounts of oat derived materials, allows further improvements concerning eg. richness and mouthfeel for the liquid oat base or oat drink.

The oat derived material may alternatively be present in an amount of 1-5% by weight dry substance, based on the weight of the liquid oat base or oat drink, and, optionally, the liquid oat base or oat drink may further comprise citrus fibre in an amount of 0.02-0.15% by weight dry substance, based on the weight of the liquid oat base or oat drink.

The liquid oat base or oat drink may comprise citrus fibre in an amount of 1-5% by weight of the oat derived material.

The citrus fibre, in combination with the levels of DP1-DP2 sugars, DP3 to DP8 and DP9 and larger polysaccharides according to variants of aspects herein, allows provision of an oat drink with desirable mouthfeel and flavour, also at such low levels of oat derived material. Further, such an oat base or oat drink allows provision of desirable mouthfeel and flavour in combination with a very low level of DP1-DP2 sugars.

According to a second aspect there is provided a method for production of a liquid oat base or oat drink, the liquid oat base or oat drink comprising an oat derived material with 1-25% by weight dry substance, based on the weight of the liquid oat base or oat drink, which method comprises providing an aqueous suspension with 1-25% by weight dry substance of oat material comprising starch; subjecting the starch within the aqueous suspension to starch degrading enzymatic treatment under formation of an aqueous suspension comprising oat derived material; and
terminating the starch degrading enzymatic treatment, wherein the aqueous suspension comprising oat derived material comprises, by dry weight of the oat derived material,
DP1 to DP2 sugars present in an amount of 7% or below, and
DP3 to DP8 oligosaccharides present in an amount of 5-40%,
thereby providing a liquid oat base or oat drink.

The method may be for production of a liquid oat base or oat drink comprising an oat derived material with 5-25% or 1-5% by weight dry substance, based on the weight of the liquid oat base or oat drink.

The method according to the second aspect may be a method for production of a liquid oat base or oat drink according to the first aspect.

The starch degrading enzymatic treatment may be conducted using one or more amylases having alpha-activity, or beta-activity, or alpha- and beta-activity. The alpha- and beta-activity may be obtained by use of one type of amylase having both alpha- and beta-activity, or by two or more types of amylase, of which one has alpha-activity and another has beta-activity.

The method may further comprise subjecting oat proteins of the oat derived material to a protein-deamidase to achieve deamidation of the oat proteins.

The protein-deamidase may be protein-glutaminase.

Deamidation using the protein-deamidase may be conducted concurrently with the starch degrading enzymatic treatment.

According to a third aspect, there is provided a liquid oat drink according to the first aspect. According to one example, the liquid oat drink may be describes as comprising an oat derived material with 9-11%, or about 10% by weight dry substance, based on the weight of the liquid oat base or oat drink, and further comprising rapeseed oil, buffering agents, minerals, salt, and vitamins. Further according to the example, the fibre content may be 0.6-0.8%, or about 0.7%, the protein content, which may comprise or consist of oat protein, may be 0.8-1.2%, or about 1%, and the fat content, which may comprise or consist of oat oil and/or rapeseed oil, may be 1.2-1.8%, or about 1.5%; 0.2-0.8%, or about 0.5%; 2.7-3.3%, or about 3.0%, by weight of the oat drink.

The buffering agents may be, for example, dipotassium phosphate.

The minerals may be selected from calcium carbonate and potassium iodide, and combinations thereof.

The vitamins may be selected from D2, riboflavin, and B12, and combinations thereof.

According to another example, the liquid oat drink may be describes as comprising an oat derived material with 2-4%, or about 3%, or 2.9%, by weight dry substance, based on the weight of the liquid oat base or oat drink, and further comprising canola oil or rapeseed oil, buffering agents, minerals, salt, vitamins, and citrus fibre. The citrus fibre for this another example was present in an amount of 0.02-0.15%, or about 0.07%, by weight of the liquid oat drink. Expressed differently, the citrus fibre was present in an amount of 1-5%, or about 2.4% by dry weight of the oat derived material.

The canola oil in this another example may be present in an amount of 0.3-0.5%, such as 0.4%, by weight of the liquid oat drink.

According to an alternative aspect, there is also disclosed herein an aspect relating to a dry or dried oat base or oat drink. The dry oat base or oat drink may be described by the liquid oat base or oat drink according to the first aspect, with the difference that the dry oat base or oat drink has an essentially higher level of dry matter. The level of dry matter may be in the range of 70-100% by weight of the dry oat base or oat drink, for example 75-95% dry matter by weight of the dry oat base or oat drink. Such dry oat base or oat drink may be used as is or may, for example, be diluted, suitably with water, to obtain a liquid oat base or oat drink as described with reference to the first aspect. The dry oat base, or oat drink may, for example, be used dry as ingredient in food products. Examples of food products include coffee whiteners, dairy substitute products, eating chocolate, and chocolate drinks, such as hot or cold chocolate drinks.

The dry oat base, or oat drink may be provided in form of a powder.

The dry oat base or oat drink may be obtained by spray drying a liquid oat base or oat drink, respectively. Other means of obtaining a dried oat base or oat drink are also possible. For example, dry oat base or oat drink may be dried, followed by micronisation into a particulate or powderous dried oat base or oat drink.

According to yet an alternative aspect, there is also disclosed herein a liquid oat base or oat drink comprising 1-25%, such as 5-25% or 1-5%, by weight of dry substance, wherein the dry substance comprises, by dry weight of the dry substance, DP1 to DP2 sugars present in an amount of 7% or below, and DP3 to DP8 oligosaccharides present in an amount of 5-40%. The dry substance further may comprise DP9 and larger polysaccharides, present in an amount of 25-75%. The dry substance may comprise an oat derived material. The dry substance may consist of an oat derived material. The oat derived material of this present aspect may be further described in analogy with variants of the first aspect, for example concerning optional content of protein, beta-glucan, and content of DP1-DP2 sugars, DP3-DP8 oligosaccharides, and any DP9 and larger polysaccharides. Levels of DP1-DP2 sugars etc. for this present aspect may be obtained from the first aspect, for example by converting the % by weight of oat derived material of the first aspect to % by weight of the dry matter of the oat base or oat drink of this present aspect.

According to a yet further alternative aspect, there is provided a liquid oat base or oat drink with reference to patent application PCT/EP2023/054089. The liquid oat base or oat drink comprises, by dry weight of the oat derived material, DP1 to DP2 sugars present in an amount of 7% or below, and DP9 and larger polysaccharides, present in an amount of 25-75%. According to this yet further alternative aspect, the liquid oat base or oat drink comprises an oat derived material with 1-25%, such as 5-25% or 1-5%, by weight dry substance, based on the weight of the liquid oat base or oat drink, wherein the oat derived material comprises, by dry weight of the oat derived material, DP1 to DP2 sugars present in an amount of 7% or below, and DP9 and larger polysaccharides, present in an amount of 25-75%. The oat derived material may be present in an amount of 1-5% by weight dry substance, based on the weight of the liquid oat base or oat drink, and, optionally, wherein the liquid oat base or oat drink further comprises citrus fibre in an amount of 0.02-0.15% by weight dry substance, based on the weight of the liquid oat base or oat drink. The oat base or oat drink of this yet further alternative aspect is further described in aspects and variants of aspects and examples of patent application PCT/EP2023/054089, to which references are made. The citrus fibre is further described according to present aspects and variants of aspects herein described.

The amounts of sugars (DP1-DP2), oligosaccharides (DP3-DP8) and polysaccharides (DP9 and larger) are not to exceed 100%.

Effects and features of the second aspect, the third aspect and alternative aspects are largely analogous to those described above in connection with the first aspect of the inventive concept. Embodiments mentioned in relation to the first aspect of the present invention are largely compatible with the further aspects of the invention.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. As used herein, the term “comprising” and variations of that term are not intended to exclude other additives, components, integers or steps.

### Material and Methodologies

Content of sugar, oligosaccharides, polysaccharides and starch have been analysed and determined by the methods below:
HPLC-RID (Zorbax Carbohydrate Analysis Column, Agilent)
HPAEC-PAD
AOAC 996.11 Total starch

Content and size of beta-glucans have been analysed and determined by the methods below:
ICC Standard Method No 166 Cereal beta-glucan determination
SEC with fluorometric calcofluor detection

The DP9 and larger polysaccharides have been determined using the AOAC 996.11 Total starch method, with and without ethanol wash, together with one or both of the HPLC-RID and the HPAEC-PAD methods.

### Definitions

### Definition of Oat Derived Material

The oat derived material means material derived from oats.

An oat derived material as used herein, thus and for example, may be obtainable from or obtained from heat-treated oats, such as steamed oat kernels. The oat kernels may further be micronized, such as milled or crushed. The oat derived material may be selected from heat-treated wet milled oats, heat-treated dry milled oats, heat-treated oat bran, heat-treated dehulled or hulled/naked dry milled oat flour. The oat derived material may comprise oat proteins, oat starch, oat fats, and oat fibres. The raw material for the oat derived material may be prepared from oats by milling groats with water to obtain a mixture comprising 5-25% by weight of dry substance, based on the weight of the liquid oat composition.

Fractions or compounds may be removed from the oats, such as, for example, insoluble fibres, which may be removed eg. before, during or after milling or crushing.

Further, the oat-derived material may be obtained by treatment of the oats comprising hydrolysis, degradation or break-down of starch of the oats. For example, starch of the oats may be subjected to enzymatic hydrolysis, such as hydrolysis by amylases. The amylases may have alpha amylase activity, or a combination of alpha amylase activity and beta amylase activity, which may be achieved by amylase providing a combined alpha- and beta amylase activity.

The weight or content of oat derived material may be the weight of oats used in the manufacturing of the oat base or oat drink. For example, if oats are hydrolysed into an oat derived material without removal of material originating from the oats, the weight of the oat derived material may be identical with or similar to the weight of the oats. Other types of oat derived material may have been obtained from hydrolysation of oats wherein part of the oats have been removed, for example removal of insoluble matter, eg. insoluble fibres, such as removal by sedimentation, decantation or filtration. For such oat derived materials, the weight or amount of oat derived material may be less than that of the oats. For practical reasons, the weight of oat derived material in an oat base or oat drink may be determined or estimated from the amount of dry matter of the oat base or the oat drink, optionally with deduction for, or taking into account of, non-oat derived additives to the oat base or oat drink.

Oat kernels, which, for example, may be used as starting material for obtaining oat derived material, may be provided with a water, or moisture, content of, for example, 10% by weight, thus and for example 1 kg of oat kernels may contribute to about 0.9 kg of dry oat material.

Contents of sugars, as well as oligosaccharides, polysaccharides and other forms of partly degraded starch is herein described with DP1, DP2, DP3-DP8, etc., whereby the figure following “DP” denotes number of saccharides in the carbohydrate (sugar, oligosaccharide, polysaccharide etc.). DP1 and DP2 sugars, thus, refer to mono- and di-saccharides and comprises sugar, whereas DP3 and above is not considered to comprise sugar, but is considered to comprise eg. oligosaccharides and/or polysaccharides. DP3-DP8 are considered to comprise oligosaccharides and DP9 and larger polysaccharides are considered to comprises polysaccharides.

For example, DP1-DP2 carbohydrates may be glucose, maltose, and sucrose.

DP1-DP2, DP3-DP8, etc., as used herein, may include the DP1, DP2, DP3 and DP8, respectively, as well as one or more of the saccharides therein between, i.e. DP4-DP7. Thus, for example, DP3-DP8 may comprise one or more of DP3, DP4, DP5, DP6, DP7, and DP8.

The term low sugar as used herein may refer to a product having a DP1-DP2 sugar content of 7% or below by dry weight of the oat derived material; or, for example, 0.5%, or below, or 0.2% or below, by weight of the liquid oat base or oat drink.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals may be used for similar elements, and wherein:

FIG. 1 is a schematic illustration of a method according to the second aspect.

### DETAILED DESCRIPTION

The present inventive concept will now be described more fully hereinafter with reference to the accompanying drawings, in which currently preferred variants of the inventive concept are shown. This inventive concept may, however, be implemented in many different forms and should not be construed as limited to the variants set forth herein; rather, these variants are provided for thoroughness and completeness, and fully convey the scope of the present inventive concept to the skilled person.

The present inventors have, after extensive research and development, found that a liquid oat base or oat drink having a low content of sugar but at the same time being associated with desirable organoleptic properties can be achieved if the oat derived material is present at 1-25%, such as 5-25% or, for example, 1-5% by weight dry substance, based on the weight of the liquid oat base or oat drink when the level of DP1 to DP2 sugars is 7% or below, and DP3 to DP8 oligosaccharides are present in an amount of 5-40%.

By tailoring both the levels of DP1-DP2 sugars and up to oligosaccharides, or even further including larger polysaccharide and/or starch molecules as described herein with aspects and examples, body and mouthfeel of the liquid oat base and oat drink is desirable and improved, while at the same time having a low or absent content of sugar.

The liquid oat base or oat drink can be used as such or with optional additional ingredients, as a beverage. In addition, it has been unexpectedly found that such an oat base or oat drink may be used as starting material or ingredient for other food products, whereby the low sugar content and organoleptic properties also may be appreciated.

The content of oat-derived material of present aspects allows a source of desirable and vegetable nutrients to be included in the oat base or oat drink, such as, for example, beta-glucan. The oat-derived material further allows for oat protein and oat fat to be included, together with, for example, any carbohydrates. In addition, the oat derived material of present aspects allows for non-dairy and vegan oat bases and oat drinks to be manufactured.

According to a first aspect there is provided a liquid oat base or oat drink comprising an oat derived material with 1-25% by weight dry substance, based on the weight of the liquid oat base or oat drink. The oat derived material comprises, by dry weight of the oat derived material, DP1 to DP2 sugars present in an amount of 7% or below; and DP3 to DP8 oligosaccharides present in an amount of 5-40%.

A carbohydrate content of the liquid oat base or oat drink may entirely be comprised by the oat derived material. Thereby, the oat base or oat drink may have as only source of carbohydrates the carbohydrates from the oat derived material. However, it is not excluded that carbohydrates from alternative sources additionally are comprised by the liquid oat base or oat drink. For example, an oat base or an oat drink that comprises oat derived material as specified in aspects herein, may further comprise compounds, including one or more of DP1-DP2 sugars, DP3-DP8 oligosaccharides, and DP9 and larger polysaccharides, obtained from other sources than oats and still be within the scope of aspects and variants of aspects disclosed herein.

The liquid oat base or oat drink may comprise 1-30% or 1-25%, such as 5-30%, 5-25%, 1-5% or 2-4%, by weight dry substance, or dry matter.

Although all dry substance of the liquid oat base or oat drink may be oat derived material, it shall be realised that a portion of the dry matter of the liquid oat base or oat drink may be oat derived material. An example of such an oat base or oat drink may be an oat base or oat drink to which other, non-oat derived, ingredients, compounds, or additives have been added.

A liquid oat base or oat drink comprising an oat derived material with 1-25% by weight dry substance, based on the weight of the liquid oat base or oat drink, may, for example, be an oat base that has oat derived material dry matter within the interval 10-250 g per kg oat base or oat drink.

A major portion by weight, or above 50%, such as within 51-100%, 75-100%, or 80-100%, by weight of the dry substance of the oat base or oat drink may be oat derived material. For example, 51-99%, 75-99%, or 80-99%, or 80-95%.

It has been found by the inventors that a too low level of DP1-DP2 sugars may have a negative impact on organoleptic properties of an oat drink, for example, mouthfeel and body, and such an oat drink may be perceived eg. as watery or thin. With variants of present aspects disclosed herein and the combination of low levels of sugars in combination with the specified DP3-DP8 oligosaccharides, organoleptic properties have been found to be very desirable. It appears that the low level of sugar at least in part is compensated for, concerning eg. mouthfeel and body, by larger level of DP3-DP8 oligosaccharides, and/or larger levels of polysaccharides including DP9 and above. In addition, it appears that the total amount of dry substance or oat derived material, as disclosed herein, have an effect and improves the oat base or oat drink, for example concerning mouthfeel and body. Thus, an oat base or oat drink has been achieved that combine a low sugar level that at the same time is rich in taste and associated with a desirable mouthfeel. In particular, it has been found that with a presence of oat derived material of 5-25% by weight dry substance, based on the weight of the liquid oat base or oat drink, such as of 7-15%, and having DP1-DP2 sugars and DP3-DP8 oligosaccharides as specified with variants of aspects herein, desirable flavour and mouthfeel can be achieved. With a presence of oat derived material of 1-5%, 1-4.5%, or 2-4%, such as around 3%, by weight dry substance, based on the weight of the liquid oat base or oat drink, and further having DP1-DP2 sugars and DP3-DP8 oligosaccharides as specified with variants of aspects herein, and a presence of citrus fibre in an amount of 0.02-0.15% by weight dry substance, based on the weight of the liquid oat base or oat drink, desirable flavour and mouthfeel can also be achieved.

The liquid oat base or oat drink may have a content of citrus fibre in an amount of 0.02-0.15%, by weight of the liquid oat base or oat drink.

Suitably, with such a content of citrus fibre, the liquid oat base or oat drink may comprise an oat derived material with 1-5% by weight dry substance, based on the weight of the liquid oat base or oat drink, for example 1-4.5% or 2-4%.

Such presence of citrus fibre may have a positive effect on mouthfeel and body of the liquid oat base or oat drink, even though the amount of oat derived material of 1-5% is at the lower end of the interval 1-25%.

The citrus fibre may be a citrus fibre suitable for use in food and beverage products. The citrus fibre may further be citrus fibre obtained from citrus peels, which may be a by-product of citrus juice manufacturing. The citrus fibre may comprise at least 80% by weight of dietary fibres comprising soluble and insoluble fibres. Thus, it shall be realised that the citrus fibre may comprise, to a minor part, or 20% by weight or less, other components than dietary fibres.

The citrus fibre may be further defined by having a pH (1%) of 3.2-4.5 and/or emulsion viscosity, cP, of 3000-4500. Further, the particle size may be described by leaving less than 5% on a 0.250 mm sieve. Yet further, the water holding capacity may be 21 or above (g/g).

For example, NUTRAVA Citrus Fiber peak (CPKelco) may be used as citrus fibre.

The herein described content of DP1-DP2, DP3 to DP8 oligosaccharides, and any carbohydrates including starch at various levels of degradation, or polysaccharides, provides the liquid oat base or oat drink with unique properties, while at the same time resulting in a product that is low in sugar content. In fact, also oat bases and oat drinks without any sugar were manufactured. However, products with a low, but present, content of sugar were described as having an improved flavour.

DP1-DP2 may be present in an amount of 1-7%, by dry weight of the oat derived material.

DP3-DP8 oligosaccharides may be present in an amount of 5-40% or 5-35%, by dry weight of the oat derived material.

In particular, the DP3-DP8 oligosaccharides may be present in an amount of 15-35%; or in an amount of 5-15%, by dry weight of the oat derived material.

Such amounts of DP3-DP8 oligosaccharides in combination with the level of DP1-DP2 sugars provides a liquid oat base or oat drink that is low in sugar, while at the same time being rich in taste and associated with a desirable mouthfeel.

80-95%, or 75-93%, or 93-97% of the liquid oat base or oat drink may be water.

It shall be appreciated that the entire dry matter of the oat base or oat drink may be oat derived material and manufactured from degradation of starch within the oat material, optionally with addition of additives or other ingredients, or removal of compounds, such as, for example, insoluble matter, such as insoluble fibres. Thereby an oat base or oat drink may be manufactured with no or little additives or other ingredients. For example, the oat base or oat drink may be manufactured from enzymatic degradation of oats. At the same time, it shall be understood and appreciated that the oat derived material of the oat base or oat drink may, to a first part, be made from eg. enzymatic degradation of oats, and to a second part may be compounds or ingredients from oats which has been added to or combined with the first part. For example, oat derived materials may be added that is selected from the list consisting of beta-glucans, oat fat, oat protein, oat derived carbohydrates, and soluble or insoluble fibres from oats including or being other than beta-glucan. It shall also be realised that the oat derived material of the liquid oat base or oat drink may entirely be provided from a combination of different separately obtained and/or provided oat derived material fractions. For example, any content of sugars, oligosaccharides, polysaccharides, beta-glucan, protein, etc, and combinations thereof, may be combined at levels or amounts described herein.

Thus, although all of the saccharide and/or starch material present in the liquid oat base or oat drink may be comprised by the oat derived material, or have an origin from oats as discussed above, it is not excluded that saccharide material, for example oligosaccharides and starch comprising partially degraded starch and DP1-DP2 sugars, that is not comprised by the oat derived material are present in the oat base or oat drink.

The oat base or oat drink as described herein may be used as a beverage as it is or used as an ingredient or starting material for other beverages or food products. In particular when the oat base or oat drink is an oat drink, the oat base or oat drink may comprise further ingredient, such as selected from fat, vitamins, salt, minerals, fibres, which may be soluble and/or insoluble, and buffering agents. Although additionally added ingredients may be oat derived, for example concerning fat, which may be oat oil, protein, which may be oat protein, and fibres, which may be beta-glucans, one or more of such additionally added ingredients may alternatively be from other sources than oat. For example, rapeseed oil and/or canola oil may be added when formulating oat drinks. It is desired that additionally added ingredients are non-dairy, vegan, vegetable and/or of non-animal source. It shall, however, not be excluded that additionally added ingredients may be of eg. animal origin and still be within the scope of the present aspects.

The oat derived material may further comprise DP9 and larger polysaccharides, present in an amount of 25-75%, by weight of the oat derived material.

In particular, the DP9 and larger polysaccharides, may be present in an amount of 25-50%, such as 30-50%; or 50-75%, by dry weight of the oat derived material.

Such content of DP9 and larger polysaccharides in combination with the level of DP1-DP2 sugars and level of DP3-DP8 oligosaccharides, provides a liquid oat base or oat drink that is low in sugar, while at the same time being rich in taste and associated with a desirable mouthfeel. Combining the DP1-DP2 sugars and DP3-DP8 oligosaccharides of the first aspect, with those levels DP9 and larger polysaccharides provides yet further improvements to the liquid oat base or oat drink as compared to tuning levels based on DP1-DP9 alone. DP9 and larger polysaccharides may be used to add yet further richness, body and mouthfeel. It shall be appreciated that this allows a high content of oat derived material, and thereby high levels of desirable components of oats, to be included in the oat base or oat drink, and allows for a desirable creaminess and flavour without having high levels of neither sugar nor DP3-DP8 oligosaccharides.

Polysaccharide content is herein referred to as DP9 and larger polysaccharides. Analysis methods described herein have been used for characterisation of oat bases and oat drinks and have allowed identification of DP1 sugar and up to DP8 oligosaccharides. However, identification of each present polysaccharide of DP9 and larger have not been made. Quantification of amounts of DP9 and larger polysaccharides have been made for the whole range from DP9 and upwards. This range shall be considered to include and quantify all polysaccharides present in the oat bases or oat drinks during the analysis, i.e. partly degraded starch from DP9 and upwards. More detailed quantification of the polysaccharides have been attempted by quantification of a fraction of larger polysaccharides using the herein disclosed AOAC 996.11 Total starch method, which method allows quantification of polysaccharides above a certain size or threshold.

The DP9 and larger polysaccharides, present in an amount of 25-75% by dry weight of the oat derived material, may comprise a fraction of larger polysaccharides, as quantified by the AOAC 996.11 Total starch method, in an amount of 15-60% by dry weight of the oat derived material.

In particular, when DP9 and larger polysaccharides are present in an amount of 25-50% by weight of the oat derived material, DP9 and larger polysaccharides may comprise the fraction of larger polysaccharides, as quantified by the AOAC 996.11 Total starch method, in an amount of 15-30% by weight of the oat derived material.

Further, when DP1 to DP2 sugars present in an amount of 2-5%, DP3-DP8 oligosaccharides present in an amount of 15-35%, and DP9 and larger polysaccharides in an amount of 30-50%, by weight of the oat derived material, DP9 and larger polysaccharides may comprise the fraction of larger polysaccharides, as quantified by the AOAC 996.11 Total starch method, in an amount of 18-27% by weight of the oat derived material.

In particular, when DP9 and larger polysaccharides are present in an amount of 50-75% by weight of the oat derived material, DP9 and larger polysaccharides may comprise the fraction of larger polysaccharides, as quantified by the AOAC 996.11 Total starch method, in an amount of 40-60% by weight of the oat derived material.

Further, when DP1 to DP2 sugars present in an amount of 1-3%, DP3-DP8 oligosaccharides present in an amount of 5-15%, and
DP9 and larger polysaccharides in an amount of 50-75%, by weight of the oat derived material, DP9 and larger polysaccharides may comprise the fraction of larger polysaccharides, as quantified by the AOAC 996.11 Total starch method, in an amount of 41-56%, such as 43-54%, by weight of the oat derived material.

For the oat base or oat drink according to the first aspect, the DP3 to DP8 oligosaccharides may be present in an amount of 15-35%.

The DP9 and larger polysaccharides may be present in an amount of 25-50%.

The liquid oat base or oat drink having a content of DP3 to DP8 oligosaccharides in an amount of 15-35%, and DP9 and larger polysaccharides present in an amount of 25-50%, may further comprise, by dry weight of the oat derived material: DP1 to DP2 sugars present in an amount of 2-5%; DP3-DP8 oligosaccharides present in an amount of 15-35%; and DP9 and larger polysaccharides in an amount of 30-50%.

Such oat bases or oat drinks may suitably be manufactured using amylases having both alpha- and beta-activity.

Such oat bases or oat drinks may have 7-15% dry substance. Thereby, the DP1-DP2 sugar content of 1-7%, by dry weight of the oat derived material, may correspond to a DP1-DP2 sugar content of 0.07-1.05% by weight of the liquid oat base or oat drink.

Such an oat base or oat drink may describe an oat drink suitable for consumption, optionally and suitably with an additional content of one or more of, for example, protein, fat, and beta-glucans.

Alternatively, such oat bases or oat drinks may have 1-7%, or 2-5%, such as 2-4%, dry substance. Thereby, the DP1-DP2 sugar content of 1-7%, by dry weight of the oat derived material, may correspond to a DP1-DP2 sugar content of 0.01-0.49% by weight of the liquid oat base or oat drink, for example, 0.2%, or below, such as 0.1-0.2%, for example 0.1-0.14%.

Such an oat base or oat drink may describe an oat drink suitable for consumption, and have an additional content of citrus fibre, and one or more of, for example, protein, fat, beta-glucans.

For the oat base or oat drink according to the first aspect, the DP3 to DP8 oligosaccharides may be present in an amount of 5-15%.

The DP9 and larger polysaccharides may be present in an amount of 50-75%.

By dry weight of the oat derived material: DP1 to DP2 sugars may be present in an amount of 1-3%; DP3-DP8 oligosaccharides may be present in an amount of 5-15%; and DP9 and larger polysaccharides may be present in an amount of 50-75%.

It is appreciated that such an oat base or oat drink, with extra low levels of DP1-DP2 sugars, may be obtained by degradation of starch using amylases having alpha amylase activity, but no, or essentially no, beta amylase activity. Such low level of sugar may be originating from a natural level of sugar, such as sucrose, present in the oats also prior to hydrolysation.

It has, thus, been found by the inventors that the liquid oat base or oat drink comprising DP3-DP8 oligosaccharides present in an amount of 15-35% suitably may be combined with DP9 and larger polysaccharides in an amount of 25-50%, such as 30-50%, by dry weight of the oat derived material. Such a liquid oat base or oat drink may suitably further be combined with DP1 to DP2 sugars present in an amount of 2-5%, by dry weight of the oat derived material.

It has thus further been found by the inventors that DP3-DP8 oligosaccharides present in an amount of 5-15%, suitably may be combined with DP9 and larger polysaccharides in an amount of 50-75%, by dry weight of the oat derived material. Such a liquid oat base or oat drink may suitably further be combined with DP1 to DP2 sugars present in an amount of 1-3%, by dry weight of the oat derived material, i.e. allowing slightly lower amount of sugars as compared to the liquid oat base or oat drink described herein directly above.

The liquid oat base or oat drink may comprise partly degraded starch.

10% by weight or less of the DP1 to DP2 sugar may be glucose; and 90% or more of the DP1 to DP2 sugar may be one or both of maltose and sucrose.

In particular, the DP1-DP2 sugars may comprise less than 1% glucose, or the oat derived material may be free of glucose.

The oat derived material may have 7-25% by weight dry substance, based on the weight of the liquid oat base or oat drink.

The present oat base or oat drink, thus, may combine high levels of dry substance of the oat derived material with low levels of DP1 and DP2 sugars. A higher level of dry substance, for example within 20-25% may be beneficial for manufacturing purposes, and/or for use as ingredient or starting material for food products, including oat drinks. For oat drinks, the dry substance may suitably be within 7-15%, or 8-15%, thereby providing eg. suitable viscosity, texture and mouthfeel. Although it has been unexpectedly found that even lower levels of dry substance are possible, in particular with a presence of citrus fibre. The oat derived material may have 1-7%, such as 1-5%, 1-4.5%, or 2-4% by weight dry substance and a presence of citrus fibre.

It is particularly advantageous with the present aspects and variants thereof that an oat base or oat drink having a low level of sugar is achievable while at the same time having large levels of oat derived material dry substance, eg. above 5%, such as 7% or above, for example, within the interval 7-25%. This is believed to contribute to achieving improved mouthfeel and flavour with low sugar oat bases or oat drinks. It has been found that the combination of the level of dry substance and the levels of the DP3 and higher oligosaccharides and any polysaccharides, expressed by dry weight of the oat derived material, provide beneficial properties, as compared to for example an oat drink having similar levels of DP3 and higher oligosaccharides and any polysaccharides, expressed by dry weight of the oat derived material, but at a lower total level of oat derived material in the oat base or oat drink.

Oat bases or oat drinks of present aspects and variants thereof, thus, may be manufactured having low levels of sugar without necessitating dilution of the oat bases or oat drink to low concentrations of total solids or oat derived material dry matter. Addition of thickeners etc. to compensate for dilution can be avoided.

90% by weight or more of the DP3 to DP8 oligosaccharides may be selected from the group consisting of maltotriose, maltotetraose, maltopentaose, maltohexanose, maltoheptaose, maltooctaose, and combinations thereof.

The liquid oat base or oat drink may comprise, based on the dry weight of the liquid oat base or oat drink, 5-20% protein, and 3-35% fat.

The protein may be selected from oat protein and protein from other vegetable source, and combinations thereof.

The fat may be selected from oat fat and fat from other vegetable source, and combinations thereof.

Thus, the protein and/or fat may fully, or to a part, be oat derived. Such oat derived protein and/or fat may be considered part of the oat derived material.

The liquid oat base or oat drink may comprise, based on the dry weight of the oat derived material, 5-20% protein, and 3-35% fat.

Optionally, the liquid oat base or oat drink may further comprise 0.5-10%, such as 2-10% of soluble fibres from oats, for example beta-glucan, based on the dry weight of the oat derived material.

The oat derived material may comprise 0.5-10% of soluble fibres in form of beta-glucan, of which a weight-average molecular weight and above corresponds to intact or native beta-glucans.

Thus, at least a fraction of a content of beta-glucans may be present in intact or native form. For example, 50% by weight or more of the beta-glucans may be intact beta-glucans or native beta-glucans.

Beta-glucans having a molecular weight of 50 kDa or above may be considered to be intact or native beta-glucans.

Thus, of the beta-glucans, when present in the oat base or oat drink, a weight-average molecular weight and above may have a molecular weight above 50 kDa.

The liquid oat base or oat drink may further comprise water soluble beta-glucans having a molecular weight of 50,000 Da (50 kDa) or more, such as 100,000 Da (100 kDa) or more. The water soluble beta-glucans may be comprised by the oat derived material. The oat derived material may comprise 2-6% by weight of beta-glucans, based on dry weight of the oat derived material.

Optionally, the liquid oat composition may further comprise 2-25%, such as 2-10%, of soluble fibres from oats, for example beta-glucan, based on the dry weight of the oat derived material.

The oat derived material may comprise 2-10%, or 2-6%, by weight, of beta-glucans, based on dry weight of the oat derived material.

Although the beta-glucans may be included in the oat base or oat drink together with other oat derived material and may form part of an oat starting material, the beta-glucan may also or alternatively be added separate from other oat derived material.

The liquid oat base or oat drink may further comprise, in addition to the oat derived material, additives or ingredients selected from one or more of vegetable fat, salt, buffering agent, vitamin, and mineral. The vegetable fat may be, for example, rapeseed oil.

For the liquid oat base or oat drink: 80% or more of DP1 to DP2 sugars present in the liquid oat base or oat drink; 80% or more of DP3-DP8 oligosaccharides present in the liquid oat base or oat drink; and 80% or more of any DP9 and larger polysaccharides present in the liquid oat base or oat drink, may be from or part of the oat derived material.

The DP1-DP2 sugars, the DP3 to DP8 oligosaccharides, and DP9 and larger polysaccharides, of the oat derived material, may each constitute 80% by weight or more, or 80-100% by weight, of the DP1 to DP2 sugars, the DP3-DP8 oligosaccharides, and DP9 and larger polysaccharides, respectively, present in the liquid oat base or oat drink.

All of DP1 to DP2 sugars, DP3 to DP8 oligosaccharides, and any DP9 and larger polysaccharides present in the liquid oat base or oat drink may be comprised by the oat derived material.

Thus, although all of the sugar, saccharide and/or starch material present in the liquid oat base or oat drink may be comprised by the oat derived material, or have an origin from oats as discussed herein, it is not excluded that saccharide material, for example oligosaccharides, DP9 and larger polysaccharides and DP1-DP2 sugars, that is not comprised by the oat derived material, are present in the oat base or oat drink.

Thus, it is not excluded that, for example, DP1-DP2 sugars and oligosaccharides, and/or DP9 and larger polysaccharides, from other source than oats, including, for example other cereals or legumes, are included in the oat base or oat drink in addition to the oat derived material, and still be within embodiments and examples of the present aspect.

90% or more, such as 90-100%, or 95-100% or 100% of DP1 to DP2 sugars present in the liquid oat base or oat drink; 90% or more, such as 90-100%, or 95-100% or 100% by weight of any DP9 and larger polysaccharides present in the liquid oat base or oat drink; and 90% or more, such as 90-100%, or 95-100% or 100% by weight of DP3-DP8 oligosaccharides present in the liquid oat base or oat drink, may be from, or comprised by, the oat derived material. In particular, all of DP1 to DP2 sugars, all of DP9 and larger polysaccharides, and all of DP3-DP8 oligosaccharides may be from the oat derived material, and, thus, no such material from other sources than oats may have been added the liquid oat base or oat drink.

The liquid oat base or oat drink may comprise carbohydrates comprising DP1 to DP2 sugars, DP3 to DP8 oligosaccharides, and, optionally, DP9 and larger polysaccharides wherein
80% or more, 90% or more, such as 90-100%, or 95-100% or 100% by weight of DP1 to DP2 sugars present in the liquid oat base or oat drink;
80% or more, 90% or more, such as 90-100%, or 95-100% or 100% by weight of any DP3 to DP8 oligosaccharides present in the liquid oat base or oat drink; and
80% or more, 90% or more, such as 90-100%, or 95-100% or 100% by weight of any DP9 and larger polysaccharides present in the liquid oat base or oat drink may be from, or comprised by, the oat derived material.

The liquid oat base or oat drink may be free from DP1 to DP2 sugars, DP3 to DP8 oligosaccharides, and DP9 and larger polysaccharides from one or more of soy, rice, and other cereals than oat.

The liquid oat base or oat drink may be free from compounds from one or more of soy, rice, and other cereals than oat.

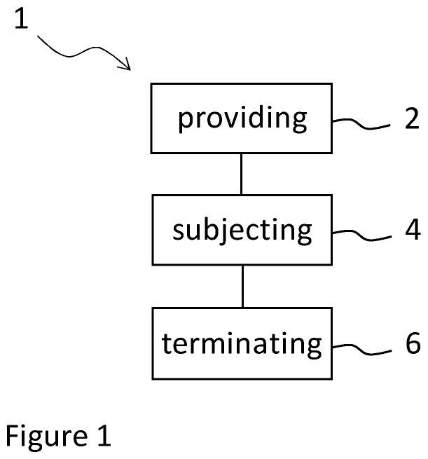

With reference to FIG. 1, a method 1 according to the second aspect for production of a liquid oat base or oat drink of the first aspect comprising an oat derived material with 1-25% by weight dry substance, such as 1-5% or 5-25%, based on the weight of the liquid oat base or oat drink will now be discussed.

The method 1 comprises providing 2 an aqueous suspension with 1-25% by weight dry substance of oat material comprising starch; subjecting 4 the starch within the aqueous suspension to starch degrading enzymatic treatment under formation of an aqueous suspension comprising oat derived material; and terminating 6 the starch degrading enzymatic treatment, wherein the aqueous suspension comprising oat derived material comprising, by dry weight of the oat derived material, DP1 to DP2 sugars present in an amount of 7% or below, and DP3 to DP8 oligosaccharides present in an amount of 5-40%, thereby providing a liquid oat base or oat drink.

The specific content of carbohydrates from DP1 and up to large starch molecules may be achieved by partly hydrolysation of starch from oats, and such an oat base or oat drink therefore may be considered to comprise partly hydrolysed or partly liquified starch. Presence of partly hydrolysed starch comprising larger starch molecules, eg. polysaccharides, and smaller oligosaccharides and down to sugars, is believed to contribute to additionally desirable flavours as well as other beneficial sensory related properties, including improved richness, creaminess, and mouthfeel, of the oat base or oat drink.

The terminating the starch degrading enzymatic treatment may be conducted when the aqueous suspension has reached a predetermined viscosity, or maximum viscosity.

It shall be realised that the viscosity decreases in the aqueous suspension with starch degradation as a result of lower molecular weight starch molecules, eg. smaller polysaccharides, provide lower viscosity as compared to higher molecular weight starch molecules, eg. larger and less degraded polysaccharides.

The terminating the starch degrading enzymatic treatment may be conducted after a predetermined time, or minimum time, of enzymatic treatment, optionally within a predetermined temperature interval. The predetermined time may be decided experimentally and be based on eg. preceding viscosity measurements or analysis of content of carbohydrates in the aqueous suspension.

For example, the terminating the starch degrading enzymatic treatment may be conducted after 0.5-4 hours, for example 1-3 hours, of enzymatic treatment. The enzymatic treatment may be conducted at a temperature within the range of 40-80° C., such as 40-70° C., or 50-80° C.

The terminating 6 the starch degrading enzymatic treatment may be by heating the aqueous suspension. For example, heating to above 70° C., such as 80-140° C. The terminating the starch degrading enzymatic treatment may alternatively be a result of decreased or terminated enzymatic activity caused by other reasons than heating, for example as the result of inactivation resulting from lack of sufficient amounts of substrate for the enzyme.

The starch degradation may be conducted using amylases with at least primarily alpha-activity, but essentially without beta-activity, which may result in an oat base or oat drink with very low or no presence of DP1-DP2 sugars. The terminating the starch degrading enzymatic treatment may be conducted when a desirable profile of starch degradation products is present in the suspension. This may be determined using several different methodologies, such as terminating after a sufficient amount of time, or when a certain viscosity of the suspension has been achieved. It is also possible, for example, to conduct suitable analysis of the suspension to investigate the levels of different carbohydrates, and, based on the analysis, terminate the enzymatic treatment. Repeatability between different batches have shown that once process parameters have been determined for a desirable oat base or oat drink in terms of eg. levels of carbohydrates from DP1 sugar and up to starch has been determined, the process may be repeated using same parameters, eg. concerning time and temperature.

Thus, the starch degrading enzymatic treatment may be conducted using one or more amylases having alpha-activity, or beta-activity, or alpha- and beta-activity.

By using amylases having alpha-activity, but with essentially no beta-activity, presence of DP1-DP2 sugars may be avoided or minimised, or at least DP1-DP2 sugars formed during the enzymatic treatment may be avoided or minimised, however DP1-DP2 sugars from other sources may be present, such as sugars, for example sucrose, naturally present in the oats. By using amylases having alpha-activity and beta-activity, DP1-DP2 sugars may be formed at desirable levels, but the levels may be predetermined and controlled, for example by terminating the enzymatic treatment.

Amylases having alpha-activity and/or beta-activity may be selected as amylase types providing mild degradation of starch. Thereby, suitable control of the starch degradation may be achieved and desirable levels or content of sugars, oligosaccharides and polysaccharides may efficiently be obtained.

The enzymatic treatment with amylases may be conducted in a single step or in two or more consecutive steps, such as two steps.

Examples of how the oat base or oat drink may be prepared is described above and with reference to FIG. 1. The oat base or oat drink may also be prepared in other ways as well without departing from claimed subject matter.

The raw material for the oat derived material may be provided in form of heat-treated dehulled oats prepared by milling groats with water to obtain a mixture comprising 1-25%, such as 5-25% or 1-5%, by weight of dry substance. Amylases, and optionally protein-deamidase may be added to the mixture in an amount and during a period of time sufficient to reach desirable partial liquification, and optional protein deamidation.

Amylase(s) may be added simultaneously with the optional protein-deamidase or before or thereafter, and the oat starch may be partially degraded/hydrolysed at 50-75° C. during a period of time to provide mono- and/or disaccharides, such as maltose, at the desired levels, and DP3-DP8 oligosaccharides, at the desired levels, and any DP9 and above polysaccharides, at any desirable level.

After starch degradation, enzyme activity may be terminated by heating the product. Then, the mixture may be cooled. The mixture may optionally be decanted or subjected to decantation. Decantation may be conducted before, during or after, or a combination thereof, terminating the enzyme activity. Decantation may be omitted if a whole grain product is to be produced. Decantation may be replaced by other suitable methodology, such as sedimentation, filtration, or centrifugation. Thereafter, the mixture or the supernatant after eg. decanting the mixture may be formulated into an oat drink, for example by adding one or more of vegetable oil, vitamins, salt, for example, sodium chloride, one or more buffering agents and one or more of mineral supplements, and optionally by dilution with water or aqueous liquid, to a desirable level of dry matter. The oat base may alternatively be used as an oat drink as it is without further formulation, or by dilution with water as only further treatment.

The method may further comprise subjecting oat proteins of the oat derived material to a protein-deamidase to achieve deamidation of the oat proteins.

The protein-deamidase may be protein-glutaminase.

Deamidation using the protein-deamidase may be conducted concurrently with the starch degrading enzymatic treatment.

Thereby, water solubility of proteins of the oat base or oat drink may be improved.

According to a third aspect, there is provided a liquid oat drink according to the first aspect. According to one example, the liquid oat drink may be describes as comprising an oat derived material with 9-11%, or about 10% by weight dry substance, based on the weight of the liquid oat base or oat drink, and further comprising rapeseed oil, buffering agents, minerals, salt, and vitamins. Further according to the example, the fibre content may be 0.6-0.8%, or about 0.7%, the protein content, which may comprise or consist of oat protein, may be 0.8-1.2%, or about 1%, and the fat content, which may comprise or consist of oat oil and/or rapeseed oil, may be 1.2-1.8%, or about 1.5%; 0.2-0.8%, or about 0.5%; 2.7-3.3%, or about 3.0%, by weight of the oat drink.

The buffering agents may be, for example, dipotassium phosphate.

The minerals may be selected from calcium carbonate and potassium iodide, and combinations thereof.

The vitamins may be selected from D2, riboflavin, and B12, and combinations thereof.

According to another example, the liquid oat drink may be described as comprising an oat derived material with 2-4%, or about 3%, or 2.9%, by weight dry substance, based on the weight of the liquid oat base or oat drink, and further comprising rapeseed or canola oil, buffering agents, minerals, salt, vitamins, and citrus fibre. The citrus fibre was present in an amount of 0.02-0.15%, or about 0.07%, by weight of the liquid oat drink. Expressed differently, the citrus fibre may be present in an amount of 1-5%, or about 2.4% by dry weight of the oat derived material. Canola oil was present in an amount of 0.4%, by weight of the liquid oat drink.

Further, the fibre content, not including citrus fibre, may be 0.09-0.24%, or about 0.2%, the protein content, which may comprise or consist of oat protein, may be 0.2-0.4%, or about 0.3%, and the oat fat content may be 0.05-0.5%, for example 0.1-0.3%, such as around 0.18-0.25%, by weight of the oat drink.

The citrus fibre may be present in an amount of 0.01-0.2%, such as 0.05-0.09%, 0.06-0.09%, or around 0.06-0.08%, such as 0.07%, by weight of the oat drink.

According to yet an alternative aspect, there is also disclosed herein a liquid oat base or oat drink comprising 1-25%, for example, 5-25% by weight of dry substance, wherein the dry substance comprises, by dry weight of the dry substance, DP1 to DP2 sugars present in an amount of 7% or below, and DP3 to DP8 oligosaccharides present in an amount of 5-40%. The dry substance further may comprise DP9 and larger polysaccharides, present in an amount of 25-75%. The dry substance may comprise an oat derived material. The dry substance may consist of an oat derived material. For example, 80-100%, such as 80-99%, of the dry substance may consists of an oat derived material. Oat derived material of this present aspect may be further described in analogy with variants of the first aspect, for example concerning optional content of protein, beta-glucan, and content of DP1-DP2 sugars, DP3-DP8 oligosaccharides, and any DP9 and larger polysaccharides. Levels of DP1-DP2 sugars etc. for this present aspect may be obtained from the first aspect, for example by converting the % by weight of oat derived material of the first aspect to % by weight of the dry matter of the oat base or oat drink of this present aspect.

Levels, or intervals, for DP1 to DP2 sugars, DP3 to DP8 oligosaccharides, and DP and larger polysaccharides, and any optional ingredients or compounds present in the liquid oat base or oat drink, expressed as % by weight of dry matter of the liquid oat base or oat drink, for the present aspect and variants thereof, may be identical with the corresponding levels of the DP1 to DP2 sugars, DP3 to DP8 oligosaccharides, and DP and larger polysaccharides, and any optional ingredients or compounds present in the liquid oat base or oat drink of the first aspect, although expressed as % by weight of the oat derived material in the first aspect and variants thereof.

For example, the liquid oat base or oat drink may comprise, by dry weight, DP1 to DP2 sugars present in an amount of 2-5%; DP3-DP8 oligosaccharides present in an amount of 15-35%; and DP9 and larger polysaccharides in an amount of 30-50%.

For example, the liquid oat base or oat drink may comprise, by dry weight, DP1 to DP2 sugars present in an amount of 1-3%, DP3-DP8 oligosaccharides present in an amount of 5-15%, and DP9 and larger polysaccharides in an amount of 50-75%.

### EXAMPLES

Two different types of oat bases according to variants of the first aspect were prepared in a process based on the second aspect.

Lab scale, pilot scale, and production scale oat bases were manufactured and analysed for content of DP1-DP2 sugars, DP3-DP8 oligosaccharides, and DP9 and larger polysaccharides. The oat bases were also sensory evaluated for mouthfeel.

Amylases used were determined for activity using a modified version of Henry's method (Henry, R. J. (1984), A rapid method for the determination of diastatic power. Journal of the Institute of Brewing, 90: 37-39).

The oat bases had oat derived material dry matter in an amount of about 10-15% by weight of the oat base.

Manufacturing of the oat bases included enzymatic treatment using protein deamidase, which was present in the enzyme mixtures used, although it will be appreciated that it may be omitted and that it had no effect on hydrolysis of starch. Protein deamidase has an effect on proteins, not starch, and makes proteins more water soluble. From the prepared oat bases, oat drinks were prepared by dilution with water to reach 10% oats, and oil and salts were added. Such oat drinks may serve as examples of oat drinks that can be manufactured when choosing to add further ingredients to the oat base.

### Example I—Laboratory Scale Low Sugar Oat Base

Dehulled, heat-treated oat kernels (100 g) were wet-milled to a slurry. Alpha amylase and amylase with alpha and beta amylase activity (together giving 0.33 U/g oat starch) and protein deamidase were added and reacted with the slurry under stirring for two hours. Viscosity was followed during the reaction time. The slurry was heated to 98° C. for 5 min, and insoluble matter removed by sieving. The resulting oat base was analysed for sugar content, and results are presented in Table 1.

### Example II—Production Scale Low Sugar Oat Base/Oat Drink

Dehulled, heat-treated oat kernels (2400 kg) were wet-milled in a colloidal mill to a slurry and directly fed into a stainless steel tank for enzyme treatment. Alpha amylase and amylase with alpha and beta amylase activity (together giving 0.33 U/g oat starch) and protein deamidase were fed into the tank in parallel with the slurry. The enzymes reacted with the slurry until the viscosity reached desired level. The enzymes were inactivated by heating and the slurry was decanted and cooled quickly. An oat drink was formulated from the resulting oat base at 10% by weight of oats material, similarly to what has been described above. The oat base and oat drink were analysed for sugars, oligosaccharides and polysaccharides including starch, and results are presented in Tables 1 and 2.

It shall be realised that both the oat base and oat drink have compositions described as follows:
having DP1 to DP2 sugars present in an amount of 2-5%,
having DP3-DP8 oligosaccharides present in an amount of 15-35%, and having DP9 and larger polysaccharides in an amount of 30-50%, by dry weight of the oat derived material.

### Example III—Laboratory Scale Extra Low Sugar Oat Base

Dehulled, heat-treated oat kernels (100 g) were wet-milled to a slurry. Alpha amylase (0.06 U/g oat starch) and protein deamidase were added and reacted with the slurry under stirring for two hours. Viscosity was followed during the reaction time. The slurry was heated to 98° C. for 5 min, and insoluble matter removed by sieving. The resulting oat base was analysed for sugar content, and results are presented in Table 1.

### Example IV—Pilot Scale Extra Low Sugar Oat Base

Dehulled, heat-treated oat kernels (42 kg) were wet-milled in a colloidal mill to a slurry and fed into a stainless steel enzyme treatment tank. Alpha amylase (0.06 U/g oat starch) and protein deamidase were added to the tank. The enzymes reacted with the slurry for two hours. The enzymes were inactivated by heating and the slurry was decanted and cooled quickly. An oat drink was formulated from the resulting oat base. The oat base and oat drink were analysed for sugars, oligosaccharides, polysaccharides including starch, and results are presented in Tables 1 and 2.

It shall be realised that both the oat base and oat drink have compositions described as follows:
having DP1 to DP2 sugars present in an amount of 1-3%,
having DP3-DP8 oligosaccharides present in an amount of 5-15%, and
having DP9 and larger polysaccharides in an amount of 50-75%, by dry weight of the oat derived material.

### Example V—Pilot Scale Oat Base

For comparison purposes, an oat base was manufactured using amylases with both alpha- and beta-activity (0.39 U/g oat starch). The breakdown of starch from oats was terminated to provide an oat base as defined in Table 1. An oat drink was formulated and UHT treated, results in Table 2. It shall be realised that both the oat base and oat drink have compositions described as follows:
having DP1 to DP2 sugars present in an amount of 20-40%,
having DP3-DP8 oligosaccharides present in an amount of 5-20%, and
having DP9 and larger polysaccharides in an amount of 10-30%, by dry weight of the oat derived material.

### Example VI—Pilot Scale Alternative Oat Base

For comparison purposes, an alternative oat base and an alternative oat drink, also having higher sugar content, were manufactured similar to what has been described under Example V, but with different levels of sugars, oligosaccharides and polysaccharides, Results are presented in Tables 1 and 2.

Neither of the oat bases and oat drinks of Examples V and VI are considered low sugar products, due to their DP1-DP2 levels.

It shall be noted that several oat bases were manufactured, and from the several oat bases several oat drinks were manufactured. Some of the manufactured oat bases and oat drinks were analysed for content of carbohydrates. Different oat sources were used for some of the oat bases, which may result in a slight but natural variation in content of carbohydrates between some of the oat bases or oat drinks.

TABLE 1
Manufactured oat bases from examples I-VI. Contents of saccharides
are given by % of dry weight of the oat derived material.

| | DP1- | DP3- | DP9- |
|---|---|---|---|
| | DP2 | DP8 | starch* |
| Example I Lab scale | 4 | — | — |
| Low sugar oat base | | | |
| Example II Production | 4 | 31 | 36 |
| scale | | | |
| Low sugar oat base | | | |
| Example III Lab scale | 2 | — | — |
| Extra low sugar oat base | | | |
| Example IV Pilot scale | 2 | 9 | 64 |
| Extra low sugar oat base | | | |
| Example V Comparison | 32 | 12 | 23 |
| oat base | | | |
| Example VI Comparison | 16 | 37 | 15 |
| Alternative oat base | | | |

*DP9-starch refers to DP9 and larger polysaccharides.

TABLE 2
Manufactured oat drinks from examples II-VI. Contents of saccharides
are given by % of dry weight of the oat derived material.

| | DP1- | DP3- | DP9- |
|---|---|---|---|
| | DP2 | DP8 | starch* |
| Example II Pilot scale | 3 | 23 | 40 |
| Low sugar oat drink | | | |
| Example IV Small pilot | 2 | 8 | 61 |
| scale | | | |
| Extra low sugar drink | | | |
| Example V Comparison | 35 | 12 | 24 |
| oat drink | | | |
| Example VI Comparison | 16 | 32 | 22 |
| Alternative oat drink | | | |

*DP9-starch refers to DP9 and larger polysaccharides.

All oat bases and oat drinks I-V (referring to oat bases and oat drinks of examples I-V) were described as having a desirable flavour and mouthfeel. Oat bases and oat drinks I-IV, being of low sugar type, have considerably lower levels of DP1-DP2 sugars than oat base and oat drink V, still they are described as having comparable organoleptic properties, which is believed to be a result of the unique carbohydrate profiles of the samples. Oat drink and oat base I and II have been considered to have an even more desirable flavour than oat drink and oat base III and IV. Surprisingly, oat drinks and oat bases I-IV of low or extra low sugar have mouthfeel and body comparable to oat base and oat drink V, described as rich and creamy, but perceived as less sweet. Notably, the DP3-DP8 level is similar to or higher in oat bases and oat drinks I-IV, as compared to oat bases and oat drinks V, which combined with considerably higher levels of DP9 and higher polysaccharides of oat bases and oat drinks I-IV, appear to compensate for low levels of DP1-DP2 sugars.

Comparing example VI having similar levels of DP3-DP8 oligosaccharides but remarkably lower levels of DP9 and larger polysaccharides compared to the oat bases and oat drinks of examples I-IV, and aspects herein, was perceived as having thin, i.e. less desirable, body in spite of having considerably higher level of DP1-DP2 sugars.

Comparing tests have also been conducted with oat bases and oat drinks having lower total amounts of dry matter, which were perceived as having undesirably lower body and mouthfeel.

It is concluded from the examples and data in tables 1 and 2 that oat bases and oat drinks from examples I-IV comprises 5-25%, or 7-15%, by weight of dry substance, wherein the dry substance comprises, by dry weight of the dry substance, DP1 to DP2 sugars present in an amount of 7% or below, and DP9 and larger polysaccharides, present in an amount of 25-75%. The dry substance further comprises DP3 to DP8 oligosaccharides present in an amount of 5-40%.

The oat bases and oat drinks from examples I-IV may also be described as having a dry matter content of 5-25%, or 7-15%, by weight of the liquid oat base or oat drink, and comprising DP1 to DP2 sugars present in an amount of 0.1-1%, or 0.1-0.6%, by weight of the oat base or oat drink; DP3-DP8 oligosaccharides present in an amount of 0.5-10%, or 0.5-5%, by weight of the oat base or oat drink; and DP9 and larger polysaccharides in an amount of 3-10%, or 4-9%, by weight of the oat base or oat drink.

### Example of Oat Drink Having Lower Amount of Oat Derived Material:

Even though it has been found that it is beneficial with an oat drink or oat base according to variants of aspects herein having 5-25%, or 7-15% by weight of dry substance, and that it is possible to manufacture such oat bases or oat drinks that provides a low level of sugar with richness and creaminess, it has unexpectedly been found that an oat base or oat drink having even lower level of dry substance and sugars is achievable with suitable richness and flavour. For example, a low sugar oat base made according to Example II of Table 1, was diluted further with water and formulated into an oat drink with a level of oat derived material of about 3%, more precisely 2.9%, by weight of the oat drink. The oat drink had a presence of citrus fibre within 0.02-0.15%, or 0.05-0.09%, such as 0.06-0.09%, by weight dry substance, based on the weight of the liquid oat base or oat drink by weight and the drink was found to provide a suitable and desirable richness and flavour.

Thus, further provided is an oat base or oat drink according to a variant of the first aspect, wherein the oat derived material is present in an amount of 1-5%, or 2-4%, by weight dry substance, based on the weight of the liquid oat base or oat drink and further comprising citrus fibre in an amount of 0.02-0.15%, or 0.05-0.09%, such as 0.06-0.09%, by weight of the oat base or oat drink.

The liquid oat drink was described as having a somewhat thinner taste as compared to oat drinks of the other examples having higher amount of oat derived material, but still providing a thickness and flavour that makes it desirable for use as an oat drink. It shall be understood and noted that this liquid oat drink, having a relatively low level of oat derived material, has very low level of sugar of 0.2%, or below, or 0.15% or below, such as around 0.12% or below, by weight of the oat drink.

Without a content of citrus fibre, the liquid oat drink was found to be too thin and not having sufficient richness.

Different levels of citrus fibre was tested at the level of oat derived material around 3% by weight of the oat drink, and 0.06-0.09%, or around 0.06-0.08%, and in particular around 0.07%, by weight of the oat drink, was found best. 0.05% may be perceived as providing a too thin or watery oat drink, and 0.1% may be perceived as providing a too thick or viscous oat drink.

The citrus fibre may be a citrus fibre suitable for use in food and beverage products. The citrus fibre may further be citrus fibre obtained from citrus peels, which may be a by-product of citrus juice manufacturing. The citrus fibre may comprise at least 80% by weight of dietary fibres comprising soluble and insoluble fibres. Thus, the citrus fibre may comprise other components that dietary fibres.

The citrus fibre may have an effect on flavour and may add less desirable flavour.

It was found that the citrus fibre suitably may be further defined by having a pH (1%) of 3.2-4.5 and/or emulsion viscosity, cP, of 3000-4500. Further, the particle size may be described by leaving less than 5% on a 0.250 mm sieve. Yet further, the water holding capacity may be 21 or above (g/g).

For example, NUTRAVA Citrus Fiber peak (CPKelco) was found suitably for use as citrus fibre.

The citrus fibre was found to contribute to, for example, adding richness and mouthfeel, and reduce watery sensation to the oat drink. A plurality of food grade citrus fibres are available and may suitably be selected to have a low or negligible negative impact, or a neutral impact, on flavour. Further advantages with citrus fibre include that it is obtained from a natural source.

Different citrus fibre products were tested with the present examples.

It was found that suitable citrus fibres may be citrus fibre suitable for use in food and beverage products obtained from citrus peels and that may comprise at least 80% by weight of dietary fibres.

It shall be appreciated that other types of citrus fibres than the one used for the present example alternatively may be used.

For this example, and the oat drink having an oat derived material with about 3% by weight dry substance, based on the weight of the liquid oat base or oat drink, canola oil was added in an amount of 0.3-0.5%, or about 0.4% by weight of the oat drink, and the total amount of fat, including oat fat from the oat derived material, was in the range of 0.5-0.7%, or about 0.6%, by weight of the oat drink. The citrus fibre was present in an amount of 0.02-0.15%, or about 0.07%, by weight of the oat drink. Expressed differently, the citrus fibre was present in an amount of 1-5%, or about 2.4% by dry weight of the oat derived material. The oat drink of the example comprised DP1 to DP2 sugars present in an amount of 0.05-0.5%, or 0.05-0.2%, or 0.05-0.15%, by weight of the oat base or oat drink; DP3-DP8 oligosaccharides present in an amount of 0.5-1.5%, or around 0.9%, by weight of the oat base or oat drink; and DP9 and larger polysaccharides in an amount of 0.5-1.5%, or about 1%, by weight of the oat base or oat drink.

1. A liquid oat base or oat drink comprising an oat derived material with 1-25% by weight dry substance, based on the weight of the liquid oat base or oat drink, wherein the oat derived material comprises, by dry weight of the oat derived material:
DP1 to DP2 sugars in an amount of 7% or below, and
DP3 to DP8 oligosaccharides in an amount of 5-40%.

2. The liquid oat base or oat drink according to claim 1, wherein the oat derived material further comprising DP9 and larger polysaccharides in an amount of 25-75%, by weight of the oat derived material.

3. The liquid oat base or oat drink according to claim 1, wherein:
the DP3 to DP8 oligosaccharides are present in an amount of 15-35%.

4. The liquid oat base or oat drink according to claim 3, wherein the DP9 and larger polysaccharides are present in an amount of 25-50%.

5. The liquid oat base or oat drink according to claim 3, comprising, by dry weight of the oat derived material:
DP1 to DP2 sugars present in an amount of 2-5%,
DP3-DP8 oligosaccharides present in an amount of 15-35%, and
DP9 and larger polysaccharides in an amount of 30-50%.

6. The liquid oat base or oat drink according to claim 1, wherein:
the DP3 to DP8 oligosaccharides are present in an amount of 5-15%.

7. The liquid oat base or oat drink according to claim 6, wherein the DP9 and larger polysaccharides are present in an amount of 50-75%.

8. The liquid oat base or oat drink according to claim 6, comprising, by dry weight of the oat derived material:
DP1 to DP2 sugars in an amount of 1-3%,
DP3-DP8 oligosaccharides in an amount of 5-15%, and
DP9 and larger polysaccharides in an amount of 50-75%.

9. The liquid oat base or oat drink according to claim 1, comprising partly degraded starch.

10. The liquid oat base or oat drink according to claim 1, wherein:
10% by weight or less of the DP1 to DP2 sugar is glucose, and
90% or more of the DP1 to DP2 sugar is one or both of maltose and sucrose.

11. The liquid oat base or oat drink according to claim 1, wherein the oat derived material has 7-25% by weight dry substance, based on the weight of the liquid oat base or oat drink.

12. The liquid oat base or oat drink according to claim 1, comprising, based on a dry weight of the liquid oat base or oat drink,
5-20% protein, and
3-35% fat.

13. The liquid oat base or oat drink according to claim 1, wherein the oat derived material comprises 0.5-10% of soluble fibres in form of beta-glucans, of which a weight-average molecular weight and above corresponds to intact or native beta-glucans.

14. The liquid oat base or oat drink according to claim 1, further comprising, in addition to the oat derived material, additives or ingredients selected from one or more of vegetable fat, vitamins, buffering agent, salt and minerals.

15. The liquid oat base or oat drink according to claim 1, wherein the oat derived material is present in an amount of 5-25% by weight dry substance, based on the weight of the liquid oat base or oat drink.

16. The liquid oat base or oat drink according to claim 1, wherein the oat derived material is present in an amount of 1-5% by weight dry substance, based on the weight of the liquid oat base or oat drink,
wherein the liquid oat base or oat drink further comprises citrus fibre in an amount of 0.02-0.15% by weight dry substance, based on the weight of the liquid oat base or oat drink.

17. A method for production of a liquid oat base or oat drink, the liquid oat base or oat drink comprising an oat derived material with 1-25% by weight dry substance, based on the weight of the liquid oat base or oat drink, wherein the method comprises:
providing an aqueous suspension with 1-25% by weight dry substance of oat material comprising starch,
subjecting the starch within the aqueous suspension to starch degrading enzymatic treatment under formation of an aqueous suspension comprising oat derived material, and
terminating the starch degrading enzymatic treatment, wherein the aqueous suspension comprising oat derived material comprises, by dry weight of the oat derived material:
DP1 to DP2 sugars in an amount of 7% or below; and
DP3 to DP8 oligosaccharides in an amount of 5-40%,
thereby providing a liquid oat base or oat drink.

18. The method according to claim 17, wherein the starch degrading enzymatic treatment is performed using one or more amylases having alpha-activity, or beta-activity, or alpha- and beta-activity.

19. The method according to claim 17, wherein the oat material comprises oat proteins and the method further comprises
subjecting the oat proteins to a protein-deamidase.

20. A liquid oat drink according to claim 1.
